(19) United States
(12) Patent Application Publication
(10) Pub. No.: US 2024/0152902 A1
(43) Pub. Date: May 9, 2024

(54) SYSTEMS AND METHODS FOR CURRENCY TRANSFER USING VIRTUAL OR AUGMENTED REALITY ENVIRONMENTS

(71) Applicant: Capital One Services, LLC, McLean, VA (US)

(72) Inventors: Samuel Rapowitz, Roswell, GA (US); Kevin Osborn, Newton Highlands, MA (US); Mia Rodriguez, Broomfield, CO (US); Kathryn Tikoian, South Orange, NJ (US)

(21) Appl. No.: 17/980,918

(22) Filed: Nov. 4, 2022

(51) Int. Cl. G06Q 20/36; G06Q 20/22

(52) U.S. Cl. CPC G06Q 20/367; G06Q 20/223

(57) ABSTRACT

Disclosed embodiments may include a system providing for currency transfer using virtual or augmented reality environments. The system may receive, from a user device, a first input indicating a first selection of a first virtual reality item associated with a user. The system may receive, from the user device, a second input indicating a first movement of the first virtual reality item. The system may determine whether the first virtual reality item is in proximity to a purchasable item. In response to determining that the first virtual reality item is in proximity to the purchasable item, the system may initiate a transfer by retrieving, from a store, transfer information regarding the purchasable item and store account information, retrieving user account information, and transmitting, to a payment processor, the user account information, the store account information, and the transfer information.

### CROSS-REFERENCE TO RELATED APPLICATION

This application relates to U.S. patent application Ser. No. ______, filed Nov. 4, 2022, bearing docket number COF0279 (029424.003561), listing Samuel Rapowitz, Kevin Osborn, Mia Rodriguez, and Kathryn Tikoian as inventors, and entitled “Systems and Methods for Currency Transfer Using Augmented Reality Environments,” the entire contents of which are hereby incorporated by reference in its entirety as if fully set forth herein.

### FIELD

The disclosed technology relates to systems and methods for currency transfer using virtual or augmented reality environments. Specifically, this disclosed technology relates to using an augmented reality environment to execute a currency transfer between two users or a user and a merchant.

### BACKGROUND

Virtual reality environments are becoming more popular with the advent of virtual reality-capable devices and headsets. Since this occurrence, many people interact with other people who they do not have physical contact with. Despite the distance, the people may want to exchange money (e.g., completing a peer-to-peer transfer), but may have limited ways to do so easily.

### SUMMARY

Disclosed embodiments may include a system for currency transfer using virtual or augmented reality environments. The system may include one or more processors, and memory in communication with the one or more processors and storing instructions that, when executed by the one or more processors, are configured to cause the system to provide for currency transfer using virtual or augmented reality environments. The system may receive, from a first user device, a first input indicating a first selection of a first virtual reality item associated with a first user. The system may also receive, from the first user device, transfer information comprising an amount to transfer to a second user. Additionally, the system may receive, from a second user device associated with the second user, a second input indicating a second selection of a second virtual reality item associated with the second user. Furthermore, the system may receive, from the first user device, a third input indicating a first movement of the first virtual reality item. The system may determine whether the first virtual reality item is in proximity to the second virtual reality item. In response to determining that the first virtual reality item is in proximity to the second virtual reality item, the system may initiate a peer-to-peer transfer by retrieving second user account information associated with the second user, retrieving first user account information associated with the first user, and transmitting, to a payment processor indicated by the first user account information, the first user account information, the second user account information, and the transfer information.

Disclosed embodiments may include a system for currency transfer using virtual or augmented reality environments. The system may include one or more processors, and memory in communication with the one or more processors and storing instructions that, when executed by the one or more processors, are configured to cause the system to provide for currency transfer using virtual or augmented reality environments. The system may receive, from a first user device, a first input indicating a first selection of a first virtual reality item associated with a first user. The system may also receive, from the first user device, transfer information comprising an amount to request from a second user. Furthermore, the system may receive, from a second user device, a second input indicating a second selection of a second virtual reality item associated with the second user. Additionally, the system may receive, from the second user device, a third input indicating a first movement of the second virtual reality item. The system may determine whether the second virtual reality item is in proximity to the first virtual reality item. In response to determining that the second virtual reality item is in proximity to the first virtual reality item, the system may initiate a peer-to-peer transfer by retrieving first user account information associated with the first user, retrieving second user account information associated with the second user, and transmitting, to a payment processor indicated by the second user account information, the first user account information, the second user account information, and the transfer information.

Disclosed embodiments may include a system for currency transfer using virtual or augmented reality environments. The system may include one or more processors, and memory in communication with the one or more processors and storing instructions that, when executed by the one or more processors, are configured to cause the system to provide for currency transfer using virtual or augmented reality environments. The system may receive, from a user device, a first input indicating a first selection of a first virtual reality item associated with a user. Also, the system may receive, from the user device, a second input indicating a first movement of the first virtual reality item. Furthermore, the system determines whether the first virtual reality item is in proximity to a purchasable item. In response to determining that the first virtual reality item is in proximity to the purchasable item, the system may initiate a transfer by retrieving, from a store, transfer information regarding the purchasable item and store account information, retrieving user account information, and transmitting, to a payment processor, the user account information, the store account information, and the transfer information.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1A is a flow diagram illustrating an exemplary method for currency transfer using virtual or augmented reality environments in accordance with certain embodiments of the disclosed technology.

FIG. 1B is a flow diagram illustrating an exemplary method for currency transfer using virtual or augmented reality environments in accordance with certain embodiments of the disclosed technology.

FIG. 2 is a flow diagram illustrating an exemplary method for currency transfer using virtual or augmented reality environments in accordance with certain embodiments of the disclosed technology.

FIG. 3 is a block diagram of an example currency transfer system used to provide currency transfer using virtual or augmented reality environments, according to an example implementation of the disclosed technology.

FIG. 4 is a block diagram of an example system that may be used to provide currency transfer using virtual or augmented reality environments, according to an example implementation of the disclosed technology.

FIG. 5 is a timing diagram of an example system that may be used to provide authentication information to a mobile device from a contactless card, according to an example implementation of the disclosed technology.

FIG. 6 is a method of key diversification that may be used to provide authentication information to a mobile device from a contactless card, according to an example implementation of the disclosed technology.

FIG. 7 illustrates key operations that may be used to provide authentication information to a mobile device from a contactless card, according to an example implementation of the disclosed technology.

FIG. 8 is a method of key diversification that may be used to provide authentication information to a mobile device from a contactless card, according to an example implementation of the disclosed technology.

### DETAILED DESCRIPTION

Since virtual reality (VR) environments allow users to interact without a physical presence near one another, traditional systems and methods for currency transfer, such as giving the other person cash or using a cell phone for funds transfer will not work without leaving the VR environment. This can be inconvenient and time consuming to users. Finally, in many situations authentication on such devices can be troublesome and require the user to leave the VR environment, which can interrupt the cohesive metaphor central to VR.

Accordingly, there is a need for improved systems and methods for currency transfer using virtual or augmented reality environments. Embodiments of the present disclosure are directed to this and other considerations.

Examples of the present disclosure related to systems and methods for currency transfer using virtual or augmented reality environments. More particularly, the disclosed technology relates to a virtual reality peer-to-peer currency transfer (e.g., a user giving or receiving money to/from another user via one account to another) and a virtual reality purchase currency transfer system (e.g., a user paying for an item at a store). The systems and methods described herein utilize, in some instances, graphical user interfaces, which are necessarily rooted in computers and technology. Graphical user interfaces are a computer technology that allows for user interaction with computers through touch, pointing devices, or other means. The present disclosure details a virtual reality environment, presented on a user device that may present virtual items using a display in conjunction with other items in a virtual reality environment. This, in some examples, may involve using input data from a camera, accelerometer, or other sensors to dynamically change the graphical user interface so that the virtual items presented to the user interact with and change with the user's virtual environment. Using a graphical user interface in this way may allow the system to conduct peer-to-peer currency exchanges between two people with a virtual reality device. By providing a graphical means to visualize currency exchanges between users, for example, the user interface of the disclosed embodiments may provide a unique improvement over existing technology. This improvement may be recognized as particularly stark in light of the limitations of existing systems, which do not allow users to visualize peer-to-peer currency transfers. The present disclosure may improve peer-to-peer transfers by tracking a first and second user's movements. Using the combined information, the system can present virtual items that each user can see on their user device to conduct a peer-to-peer transfer. Furthermore, examples of the present disclosure may also improve the speed with which computers can authenticate peer-to-peer and payment transactions by making the authentication process more straightforward with virtual reality devices. Overall, the systems and methods disclosed have significant practical applications in the virtual reality and payment processing fields because of the above-mentioned example improvements of using a virtual reality system to visualize and conduct a currency transfer, which is important to improving the above-mentioned issues of present technologies.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

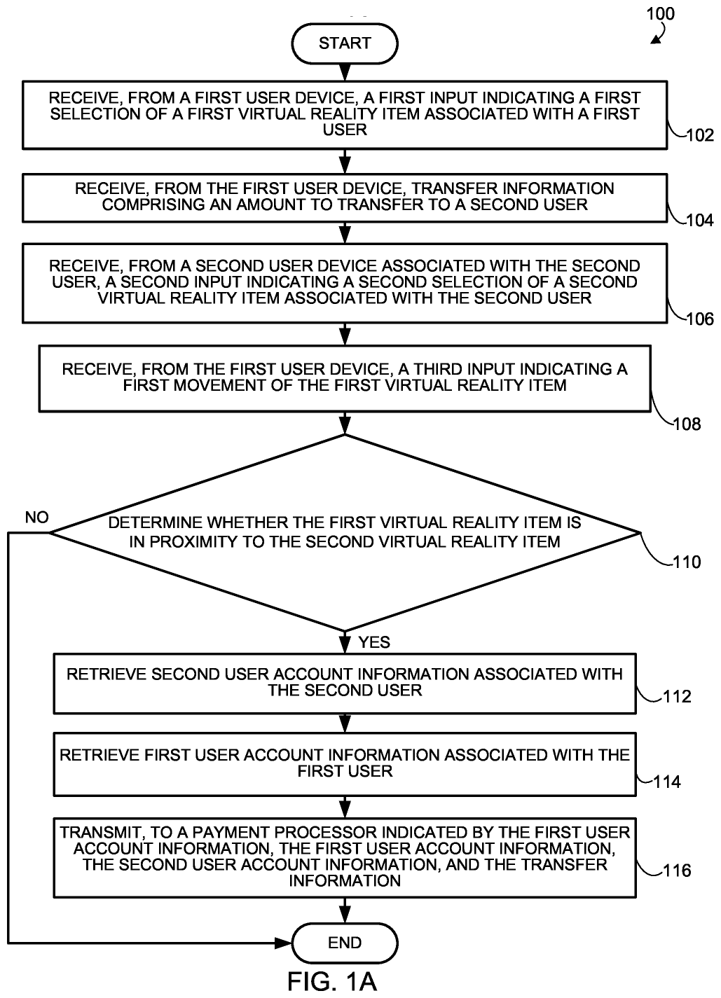

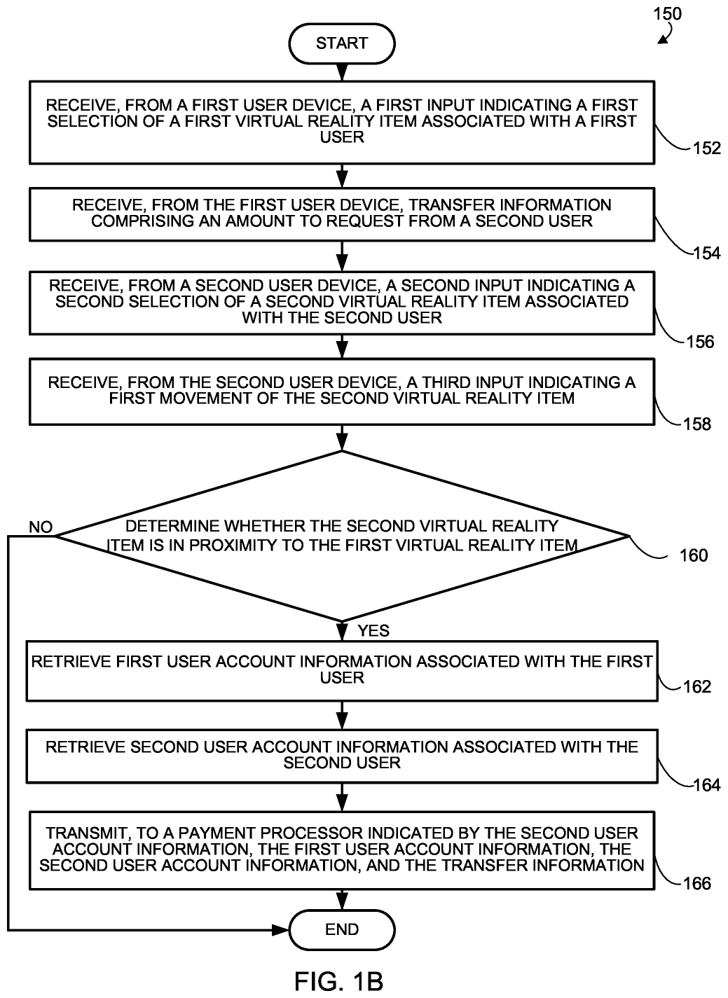

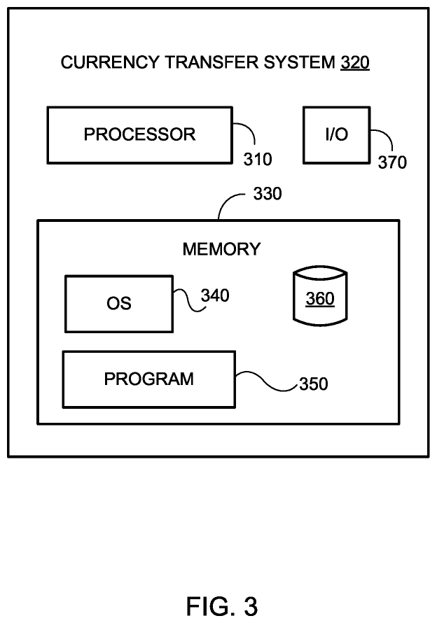

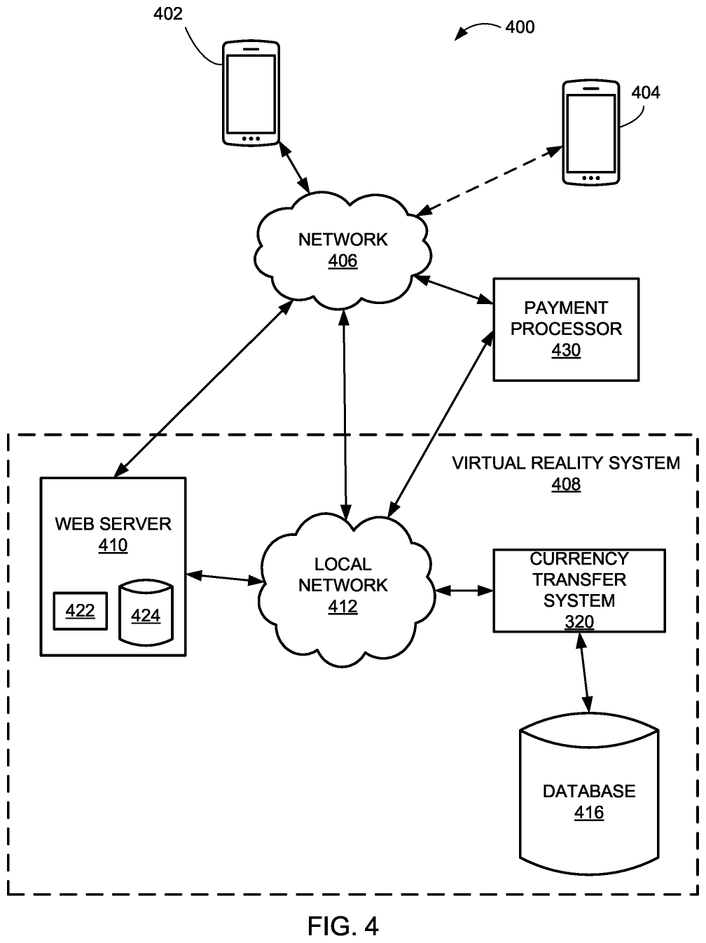

FIG. 1A is a flow diagram illustrating an exemplary method 100 for currency transfer using virtual or augmented reality environments, in accordance with certain embodiments of the disclosed technology. The steps of method 100 may be performed by one or more components of the system 400 (e.g., currency transfer system 320 or web server 410 of virtual reality system 408 or user device 402), as described in more detail with respect to FIGS. 3 and 4. In this example, a first user (the donor) gives a selected amount to a second user (the recipient).

In block 102, the currency transfer system 320 may receive from a first user device 402 a first input indicating a first selection of a first virtual reality item associated with a first user and an associated first user avatar. The avatar of the first user may be the first user's digital likeness in the virtual reality environment. Accordingly, the first user may be able to control the actions of the first user's avatar in the virtual reality environment using first user device 402. The first user device 402 may be a virtual reality device such as a headset or cell phone with virtual reality (VR) capabilities. The user device 402 may include one or more displays and one or more cameras. The user device 402 may also include an array of sensors, including, for example cameras to watch the user's environment, cameras to watch the user's actions or impressions (e.g., facial expressions, blinking, or arm movements), microphones to listen to user or the user's environment, accelerometers, gyrometers, fingerprint scanners, retinal scanners, and other similar sensors known in the art. The user device 402 may contain tactile control devices such as a joystick. The user device 402 may also include the ability to communicate using near field communication (NFC), Bluetooth, WiFi, cellular data or other technologies known in the art. The user device 402 may be linked with the user's cell phone. The user device 402 may be running software that allows it to uniquely interface with virtual reality system 408. Virtual reality system 408 and currency transfer system 320 may be able to interact directly with the sensors on user device 402. As such, the first user's avatar may be used by the first user to make selections and interactions in the virtual reality environment.

This step may involve a user selecting a first virtual reality item specific for use with currency transfer system 320. In the virtual reality environment, the user's avatar may have an inventory of items that can be selected using user device 402. The inventory of the user's avatar may contain a plethora of virtual reality items, used for a plethora of difference purposes in the virtual reality environment presented on user device 402. For example, the inventory may be visualized as a backpack or chest. Inside the backpack, the avatar may be able to select a shovel for the user to dig in the virtual reality environment. The user may instruct avatar actions using a number of different means, such as physically manipulating a mechanical input device (e.g., scrolling on a mouse), making a gesture (e.g., blinking, moving arms, or moving hands), or touching a button on the user device 402.

The first virtual reality item for currency transfer system 320 may be in the form of a wallet, bank, bank logo, transaction platform logo, currency logo, payment instrument, transaction card (e.g., a debit or credit card), piggy bank, safe, or currency symbol (e.g., bill or coin). One or more virtual reality items may represent the currency transfer system 320. The user's avatar may be able to select the virtual reality item used to select currency transfer system 320 using actions made by the user and detected by the user device 402. When the user's avatar selects the virtual reality item associated with currency transfer system 320, the user device 402 sends a signal to currency transfer system 320 indicating the selection of the virtual reality item associated with currency transfer system 320. The virtual reality system 408 may show the first virtual reality item as selected by the first user's avatar in the display of the first user on user device 402. The first virtual reality item may be shown in the virtual hand of the first user's avatar. Other users may be able to see that the first user's avatar has the first virtual reality item in his hand using their respective user devices.

The first virtual reality item may be associated with a user account of the first user. The user account may include payment information, such as a source of funds (e.g., bank account number), identification information (e.g., bank routing number, username), the payment platform (e.g., PayPal™, Venmo™), and/or contact information. Currency transfer system 320 or virtual reality system 408 may be able to save this information (e.g., to database 360 or database 416) and may contain presets so that the user can have this information automatically populate when the first virtual reality item is selected. The user device 402 may display a previously saved nickname for each account (e.g., “John's Bitcoin wallet”) and present that to the user rather than display the user's account information. This would eliminate the user's sensitive account information from having to be downloaded from database 416 and displayed on user device 402. Alternatively or additionally, the first user may setup the first virtual item using the user device 402 so that the same account is used each time and no account choice or further information is required after the primary setup.

In block 104, the currency transfer system 320 may receive, from the first user device transfer information comprising an amount to transfer to a second user. Upon the receipt of the signal that the user has selected the first virtual reality item associated with the currency transfer system 320 in block 102, currency transfer system 320 may send a prompt to the user device asking the user to enter transfer information. The transfer information may include an assortment of necessary information regarding a fund transfer. The prompt may require the user to specify, the amount to transfer (e.g., amount in dollars, amount in a cryptocurrency such as Bitcoin, in-game currency for a video game or other virtual place or platform), the payment platform (e.g., PayPal™ Venmo™), or the fund source using the nickname provided or by entering new information. The amount may be a currency (e.g., a fiat currency, such as the U.S. dollar), digital currency, or a cryptocurrency, such as Bitcoin or Ethereum. The amount may or may not be a video game currency. The prompt may include just the amount to transfer and the user's account choice. After the user selects the necessary transfer information, the user device 402 may send the currency transfer system 320, the transfer information.

In block 106, the currency transfer system 320 may receive, from a second user device associated with a second user, a second input indicating a second selection of a second virtual reality item associated with the second user and an associated second user avatar. The second user device 404 may be largely similar to first user device 402 and may contain the same sensors. The second user's avatar may have access to a second inventory full of their virtual reality items. The operation of the second user's avatar selecting the second virtual reality item may be largely similar to the first user's avatar selecting the first virtual reality item. The second user's avatar may work in a largely similar way to the first user's avatar.

The second virtual reality item for currency transfer system 320 may be in the form of a wallet, bank, bank logo, transaction platform logo, currency logo, payment instrument, transaction card (e.g., a debit or credit card), piggy bank, safe, or currency symbol (e.g., bill or coin). One or more virtual reality items may represent the currency transfer system 320. The user may be able to select the virtual reality item used to select currency transfer system 320. The second virtual reality item may be represented by the same image or figure as the first virtual reality item. When the user's avatar selects the virtual reality item associated with currency transfer system 320, the second user device 404 sends a signal to currency transfer system 320 indicating the selection of the virtual reality item associated with currency transfer system 320. The virtual reality system 408 may show the second virtual reality item as selected by the second user's avatar in the display of the second user. The second virtual reality item may be shown in the virtual hand of the second user's avatar. Other users may be able to see that the second user's avatar has the second virtual reality item in his hand.

The second virtual reality item may be associated with a user account of the second user. The user account may include payment information, such as a source of funds (e.g., bank account number), identification information (e.g., bank routing number, username), the payment platform (e.g., PayPal™, Venmo™), and/or contact information. Currency transfer system 320 or virtual reality system 408 may be able to save this information (e.g., to database 360 or database 416) and may contain presets so that the user can have this information automatically populate when the first virtual reality item is selected. The user device 402 may display a previously saved nickname for each account (e.g., “Scott's Bitcoin wallet”) and present that to the user rather than display the user's account information. This would eliminate the user's sensitive account information from having to be downloaded from database 416 and displayed on user device 402. Alternatively, the second user may setup the second virtual item so that the same account is used each time and no account choice or further information is required after the primary setup. The action of both users selecting the first and second virtual items is analogous in the physical world to both users taking out their wallets, with one user preparing to hand over a dollar and the other user preparing to receive it.

In block 108, the currency transfer system 320 may receive, from the first user device, a third input indicating a first movement of the first virtual reality item. The one or more sensors, as described in the paragraphs above, may be used to detect the third input, which the system may recognize as constituting a movement. The requirements to be recognized as a movement may have to meet certain thresholds as defined by the system (e.g., speed thresholds, gyroscopic thresholds). The sensor data may be filtered before being used to define movements. With both user's avatars having selected the first and second virtual items, which are both associated with the currency transfer system, the currency transfer system 320 is aware that a potential transfer may take place. Both users may be able to see that the other user's avatar is holding a virtual item associated with currency transfer system 320 using displays associated with their respective user devices 420. Each user's avatar may be able to move around the virtual item within the virtual environment. The virtual item may remain in the user's avatar's virtual hand. The first user may make a third input using the user device 402 that causes their avatar to move the first virtual item. This input could be made in any of the ways described using the virtual reality device (user device 402) above. The user device 402 may send an indication to the currency transfer system 320 that the first user has indicated for their avatar to move the first virtual reality item in a certain way. The third input by the first user may be equivalent to accepting the transfer and may be an acknowledgement of an agreement to transfer (similar to e.g., when a consumer at a grocery store signs a receipt, when a person clicks a buy button when purchasing an item online).

The third input may be made by the first user to “accept” the transfer and may have a variety of different forms. The acceptance input may be a plethora of different inputs involving one user or both users, as determined by currency transfer system 320. Since, in this example, the first user is the donor and is deciding the amount, the first user may be solely required to complete the acceptance action. Alternatively, the first user and second user may both be required to complete the acceptance action. The currency transfer system 320 may detect that the first user may move the first virtual item to touch or be close (e.g., within a predetermined distance in the virtual reality space) to the second virtual item of the second user. Moving the first virtual item close to the second virtual item, as detected by currency transfer system 320, may allow the first user's avatar to “use” the first virtual item and complete the transfer to the second user. The first user may have instruct their avatar to hold the first virtual item close to the second virtual item for a certain predetermined number of seconds, as discussed in block 110, and determined by currency transfer system 320.

Furthermore, the acceptance input could require both the first user and the second user to both “use” the virtual reality items at the same time while a certain predetermined distance from each other, as determined by currency transfer system 320. “Using” the items may require the users to press a certain button on their user device 402 or complete a certain virtual action (e.g., virtual jumping). The buttons may have to be pressed or the action may have to be completed by both users within a certain amount of time of each other. The input required for acceptance may require simply that the two user's avatars are within a certain virtual distance from each other, and the first user's avatar has selected a first virtual item and the second user's avatar has selected a second virtual item. The acceptance input may further require that the two user's avatars be virtually looking at one another or be each looking at the virtual object to accept the transfer. The acceptance input may be a virtual handshake or other greeting (e.g., wave, thumbs up, smile) between avatars while holding the virtual objects. Currency transfer system 320 may be able to determine a number of different acceptance inputs.

Alternatively, the acceptance input may not be visible in the virtual reality environment. The acceptance input may be an action made by the first user in the first user's physical environment and detected by buttons or sensors of user device 402. Acceptance input of this nature may be a blink in a certain fashion or a finger motion. Acceptance input may also be made in a similar manner for the second user using the second user device 404.

In block 110, the currency transfer system 320 may determine whether the first virtual reality item is in proximity to the second virtual reality item. The currency transfer system 320 may constantly monitor the location and movement of the first virtual reality item and second virtual reality item. The currency transfer system 320 may constantly monitor a comparison of the location and movement of the first virtual reality item compared to the second virtual reality item. Alternatively, the virtual reality system 408 may also monitor the location and movement of the first virtual reality item and second virtual reality item and send a message to the currency transfer system 320 when a certain relationship between the first and second virtual reality items occurs.

The currency transfer system 320 may use a number of methods to determine whether the first virtual reality item is in proximity to the second virtual reality item. This may include measuring a virtual distance from the first virtual reality to the second virtual reality item and determining whether the virtual distance is less than a predetermined threshold for a predetermined amount of time. For example, the virtual distance may indicate a certain proximity of closeness from the first virtual reality item to the second virtual reality item (e.g., if the first virtual reality item is within 6 virtual inches of the second virtual reality item). The virtual distance required may be zero (e.g., where the first virtual item must touch the second virtual item). The predetermined threshold may be preset and general (e.g., 6 virtual inches) or situationally specific (e.g., 6 virtual inches when standing on flat non-moving virtual ground, but 18 virtual inches when standing on moving virtual ground). The predetermined threshold may be changed based on user preferences, or adaptive based on user habits.

Furthermore, the first virtual reality item may be required to be within the predetermined distance of the second virtual reality item for a predetermined amount of time (e.g., 5 seconds). The predetermined time threshold prevents accidental transfers where the first virtual item was within the predetermined distance to the second virtual reality item, but the first user did not intend to make the transfer. If a predetermined time threshold is required to complete the transfer, the virtual reality environment may display an indicator showing both the first user and the second user how much time is remaining for the transfer to occur, and, therefore, how much time the users have to continue to hold the distance of the first or second virtual reality item. The indicator may have a variety of features and may count up or count down. The indicator may be a graphic showing a percentage or may show the number of seconds remaining. The predetermined time threshold may be preset and general (e.g., always 5 seconds) or situationally specific. The predetermined time threshold may be changed based on user preferences.

In response to the currency transfer system 320 determining that the first virtual reality item is in proximity to the second virtual reality item, and, therefore, the acceptance of transfer, the currency transfer system 320 may generate a graphical indication of the payment transfer. The graphical indication of payment transfer may be a simple phrase presented in the virtual reality environment (e.g., “Payment transfer accepted”) and may be visible to both the first user and the second user. Alternatively, the graphical indication of payment transfer may be a symbol connected with a funds transfer (e.g., $) or may be a two-dimensional or three-dimensional animation (e.g., bills or coins flying from one user's avatar's hand or the virtual item to the other user's avatar's hand or virtual item). The funds in the animation may correspond to the types of funds used to transfer (e.g., if the transfer involves a U.S. dollar bank transfer, then the animation may show a fictionalized graphical image of dollars; if the transfer involves Bitcoin, then the animation may show a fictionalized graphical image of Bitcoin). The animation may correspond to the amount of the transaction (e.g., if the first user accepts the transfer of $20, then the animation of the dollar flying from the first user to the second user would include a $20 bill; if the transfer was for $35, the animation may include a $20 bill, a $10 bill, and a $5 bill).

In block 112, the currency transfer system 320 may retrieve second user account information associated with the second user. Once the transfer has been accepted by the first user, currency transfer system 320 may retrieve the second user's account information from the second user's profile from database 360 or database 416. The second user may have entered their account information when selecting the second virtual reality item in block 106 and the information may have been stored to database 360 or database 416. Alternatively, the second user may have pre-entered account information for use with the second virtual reality item and the information was stored in database 360 or database 416. The second user account information may contain identification information (e.g., bank account number, routing number, username) and the payment platform (e.g., PayPal™, Venmo™).

In block 114, the currency transfer system 320 may retrieve first user account information associated with the first user. The first user may have entered their account information when selecting the first virtual reality item in block 102 and the information may have been stored to database 360 or database 416. Alternatively, the first user may have pre-entered account information for use with the first virtual reality item and the information was stored in database 360 or database 416. The first user account information may contain identification information (e.g., bank account number, routing number, username) necessary to move funds between users, the payment platform (e.g., PayPal™, Venmo™), and/or contact information. Transfer information, such as the amount to transfer (e.g., amount in dollars, amount in a cryptocurrency such as Bitcoin), and the payment platform (e.g., PayPal™, Venmo™) may be retrieved by the currency transfer system 320 in this step.

In block 116, the currency transfer system 320 may transmit, to a payment processor 430 indicated by the first user account information, the first user account information, the second user account information, and the transfer information. The payment processor 430 may be a 3^{rd} party server connected through the internet or may be part of, or directly attached to, currency transfer system 320. The transmission to the payment processor 430 may involve a publish subscribed messaging system (PSMS), such as MQTT, where the virtual reality system 408 can communicate directly with the payment processor 430 using a permissioned messaging service. Alternatively, the currency transfer system 320 may transmit the information to the payment processor 430 using a queue-based messaging system. The currency transfer system 320 may determine which payment processor 430 is appropriate for the transfer and then send the information to that payment processor 430.

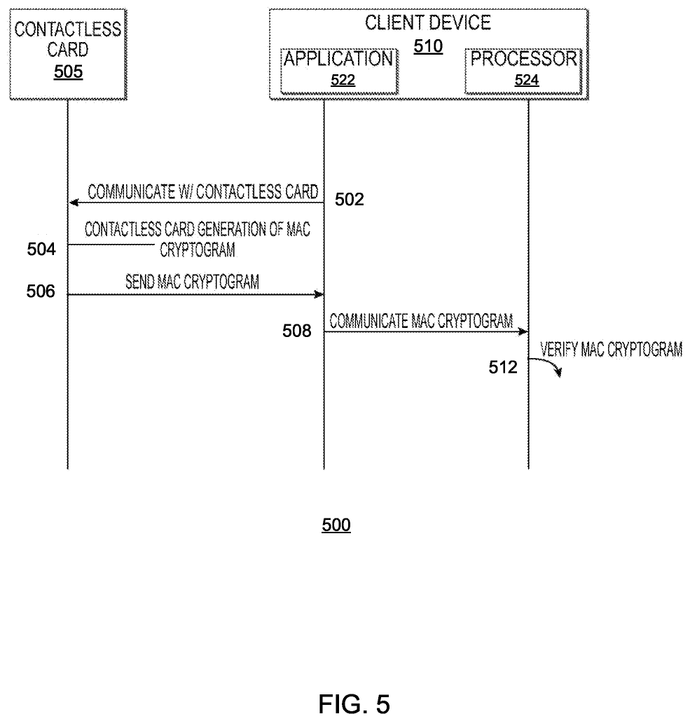

Before transmitting the account and transfer information to the payment processor 430, the currency transfer system 320 may determine that authentication is required from either the first user, the second user, or both. The currency transfer system 320 may transmit to the first user device 402 a request to authenticate the transfer. This may require the first user to provide authentication information to the first user device. Authentication information may be a password, a verification, a retinal or iris scan, and fingerprint scan, an authentication gesture, placing a financial transaction card close to user device 402 to allow user device 402 to read the financial transaction card using NFC (e.g., using a gesture from the transaction card to the user device, or tapping the card to the user device), using a camera on the user device 402 to scan a financial transaction card and recognize the numbers using optical character recognition (OCR), among other methods. The authentication information may be transmitted by a contactless payment card in accordance with the methods discussed in reference to FIGS. 5 through 8, wherein the user device 402 may be referred to as the client device. An authentication gesture may be a specific or unique action, designated by the user that can be perceived or sensed by the user's device and indicates that the user is authenticated. Furthermore, if the user has an additional user device (e.g., if a user had a VR headset and a smartphone), the currency transfer system 320 may be able to send a signal to the additional user device using a network asking the user to authenticate (e.g., the currency transfer system 320 knows the user's phone number and sends the user a text message asking the user to authenticate the transaction).

The first user device 402, having received the information, may send the authentication information to currency transfer system 320. Currency transfer system 320 may have the ability to determine if the first user is authenticated and can make the peer-to-peer transfer. Currency transfer system 320 may store, with the first user account, verification information that can compared to the received authentication information to determine if the authentication information is legitimate. Similar methods may be used to authenticate the second user if the currency transfer system 320 determines that authentication is required for the second user.

Alternatively, currency transfer system 320 may receive an indication after transmitting the first user account information, the second user account information, and the transfer information from the payment processor 430 that authentication is required from the first user, the second user, or both. Currency transfer system 320 may receive the authentication information from the user's respective devices 402, 404 and relay the authentication information to the payment processor 430. The payment processor 430 may determine if the first user is authenticated. Similar methods may be used to authenticate the second user if the currency transfer system 320 determines that authentication is required for the second user.

Before transmitting the account and transfer information to the payment processor, the currency transfer system 320 may determine if the account transfer information given by the first user and the second user is compatible. For example, if the first user gives a bank account information for a bank account using U.S. dollars and the second user provides a cryptocurrency address for an account using Bitcoin, the system may decline the transaction and ask one or both users for another payment method. Alternatively, the system may send both users a warning. In another example, the system may exchange one currency for the other and complete the transfer. The system may charge one or more users for an exchange fee. One or both users may be able to choose one or multiple of the above options when setting up the associated user account. In some circumstances, the payment processor 430 may be indicated by the first user account information or the account information of the donor. Alternatively, the payment processor 430 may be indicated by the transfer information or the second user account information.

FIG. 1B is a flow diagram illustrating an exemplary method 150 for currency transfer using virtual or augmented reality environments, in accordance with certain embodiments of the disclosed technology. The steps of method 150 may be performed by one or more components of the system 400 (e.g., currency transfer system 320 or web server 410 of virtual reality system 408 or user device 402), as described in more detail with respect to FIGS. 3 and 4. In this example, a first user (the recipient) requests a selected amount from a second user (the donor).

Method 150 of FIG. 1B is similar to method 100 of FIG. 1A. The descriptions of blocks 152 and 156 in method 150 are similar to the respective descriptions of blocks 102 and 106 of method 100 and are not repeated herein for brevity. However, blocks 154, 158, 160, 162, 164, and 166 are different from blocks 104, 108, 110, 112, 114, and 116 and are described below.

In block 154, the currency transfer system 320 may receive, from the first user device, transfer information comprising an amount to request from a second user. Unlike method 100, where the first user is the donor and the donor chooses the amount to give the recipient, method 150 involves the first user being the recipient and the recipient requests an amount from the donor. In block 154, unlike block 104, the recipient completes and sends the transfer information to currency transfer system 320. Once the first user enters the transaction information and requested amount, the second user may be able to see the requested amount or transaction information by looking at the first user or looking at the first virtual item. The display of the requested amount or transaction information may be a static or animated text or graphic. Other than the differences stated, the information regarding block 104 also applies to block 154 and is not repeated herein for brevity.

In block 158, the currency transfer system 320 may receive, from the second user device, a third input indicating a first movement of the second virtual reality item. In block 158, unlike block 108, the currency transfer system 320 receives information regarding the movement of the second virtual reality item, rather than receiving the first virtual reality item. Since in method 150, the recipient (first user) is the user choosing the amount, the donor (second user) must accept the transfer. The virtual reality item associated with the donor is monitored as the donor is the user accepting the transfer. Other than the difference that the second virtual reality item (the virtual reality item associated with donor) is received by the currency transfer system 320, the information regarding block 108 also applies to block 158 and is not repeated herein for brevity.

In block 160, the currency transfer system 320 may determine whether the second virtual reality item is in proximity to the first virtual reality item. Like block 110, the donor has to accept the transfer. Therefore, currency transfer system 320 may analyze the movement or use of the second virtual reality item in comparison to the first virtual reality item to determine if transfer acceptance has occurred. Other than this difference, the information regarding block 110 also applies to block 160 and is not repeated herein for brevity.

In block 162, the currency transfer system 320 may retrieve the first user's account information and the transfer information. This is similar to block 114 and information regarding block 114 also applies to block 162 and is not repeated herein for brevity.

In block 164, the currency transfer system 320 may retrieve the second user's account information. Block 164 is temporally interchangeable with block 162, meaning that block 162 can be performed before block 164 or block 164 can be performed before block 162. Block 164 is similar to block 112 and information regarding block 112 also applies to block 164 and is not repeated herein for brevity.

In block 166, the currency transfer system 320 may transmit, to a payment processor 430 indicated by the second user account information, the first user account information, the second user account information, and the transfer information. Unlike block 116, the payment processor 430 may be indicated by the second user account information. The second user account information may be used because the second user is the donor. Other than this difference, the information regarding block 116 also applies to block 166 and is not repeated herein for brevity.

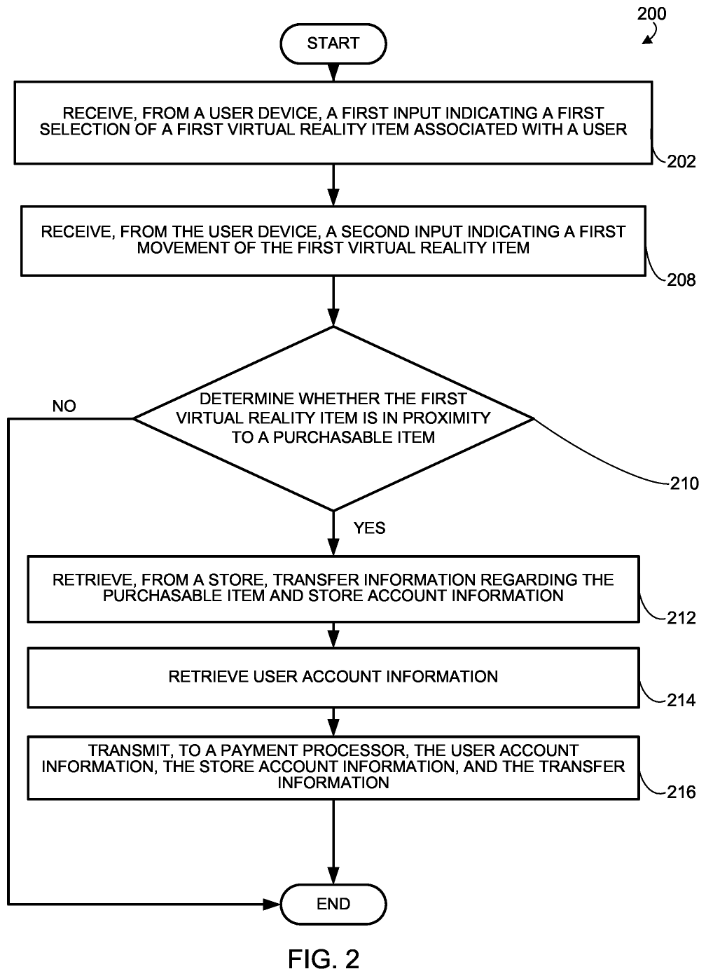

FIG. 2 is a flow diagram illustrating an exemplary method 200 for currency transfer using virtual or augmented reality environments, in accordance with certain embodiments of the disclosed technology. The steps of method 200 may be performed by one or more components of the system 400 (e.g., currency transfer system 320 or web server 410 of virtual reality system 408 or user device 402), as described in more detail with respect to FIGS. 3 and 4. In this example, a first user pays for an item using the system.

Method 200 of FIG. 2 is similar to method 100 of FIG. 1A, except that method 200 may not include blocks 104 and 106 of method 100. The descriptions of blocks 202 and 208 are similar to the respective descriptions of blocks 102 and 108 of method 100 and are not repeated herein for brevity. However, blocks 210, 212, 214, and 216 are different from blocks 110, 112, 114, and 116 and are described below.

In block 210, the currency transfer system 320 may determine whether the first virtual reality item is in proximity to a purchasable item. Block 210 may generally be similar to block 110, except block 210 uses currency transfer system 320 to pay for an item that is for sale rather than making a peer-to-peer transfer. The second virtual item of block 110 is replaced by a purchasable item. The purchasable item may be an item that the buyer can purchase in the virtual environment. The purchasable item may be located in a virtual store inside the virtual environment. The user may need to instruct their avatar to place the virtual reality item near the purchasable item in order to accept the transfer. Alternatively, the currency transfer system 320 may need to detect that the user's avatar touched the virtual reality item to the purchasable item to accept the transfer. As with block 210, there are many possible ways that the user may be able to accept the transfer. Other than these differences, the information regarding block 110 also applies to block 210 and is not repeated herein for brevity.

In block 212, the currency transfer system 320 may retrieve, from the store, transfer information regarding the purchasable item and store account information. Account information may include information necessary to move funds between users. Store account information may include payment information, such as a source of funds (e.g., bank account number), identification information (e.g., bank routing number, username), the payment platform (e.g., PayPal™ Venmo™), and/or contact information. Transfer information may include an assortment of necessary information regarding a fund transfer. The prompt may require the user to specify, the amount to transfer or the cost of the item (e.g., amount in dollars, amount in a cryptocurrency such as Bitcoin) and the payment platform (e.g., PayPal™, Venmo™). Transfer information, such as the price, may be displayed within the virtual environment when the user's avatar looks at the purchasable item. The transfer information may be displayed as a two-dimensional or three-dimensional text or figure. The text or figure containing the transfer information may be animated.

The transfer information and store account information may be retrieved in a variety of ways. Specifically, the transfer information and store account information may be stored on database 360 or database 416. The currency transfer system 320 may be able to retrieve the transfer information and store account information from the databases. Alternatively, the transfer information and store account information may be stored securely on a 3^{rd} party server that the currency transfer system 320 can access through a network. The transfer information and store account information may require a specific code or link to access. The specific code may be associated with the purchasable item or found in the virtual reality environment near the purchasable item (e.g., within the store). The specific code may be represented by a virtual reality QR code. The user may, after accepting the transfer, be able to scan a QR code present in the virtual reality environment. The QR code may appear in response to accepting the transfer. Placing the virtual reality item near the QR code, or touching the virtual reality to the QR code, may also constitute acceptance of the transfer and allow the user to scan the QR code. The QR code may be present as a distinct item within the virtual environment that can be exposed or unlocked only for users after accepting a transfer. This creates an extra layer of security for shops, merchants, or stores within the virtual environment.

In block 214, the currency transfer system 320 may retrieve user account information. Block 214 may be largely similar to block 114. The user account information may contain the same user account information as disclosed in method 100. This may not include transfer information. Generally, the information regarding block 114 also applies to block 214 and is not repeated herein for brevity.

In block 216, the currency transfer system 320 may transmit, to a payment processor 430, the user account information, the store account information, and the transfer information. Block 216 may be largely similar to block 116. However, the payment processor 430 may be determined by the transfer information or the store account information rather than the user account information. Generally, the information regarding block 116 also applies to block 216 and is not repeated herein for brevity.

Moreover, as in block 116, the currency transfer system 320 may be able to determine if a user is authenticated based on a plurality of sensor inputs. Currency transfer system 320 may also be able to receive a direction, from the payment processor 430, that authentication is required. The currency transfer system 320 may then relay to the user device that authentication is needed. The user may then authenticate using one of the numerous methods on the user device. Once completed, the user device may relay the authentication information to the currency transfer system 320. The currency transfer system 320 may relay the authentication information back to the payment processor 430. The payment processor 430 can then determine if the user is authenticated. The payment processor 430 may send a payment confirmation to currency transfer system 320. The currency transfer system 320 may relay the payment confirmation to both the user and the store.

After receiving notification of the payment, the store may allow the user's avatar to select and take the purchasable item. The user may be able to add the purchasable item to their inventory (if a virtual item).

FIG. 3 is a block diagram of an example currency transfer system 320 used to aid users in transferring currency according to an example implementation of the disclosed technology. The operations of currency transfer system 320 may be completed by a server or may be completed by the first user device 402. According to some embodiments, the user device 402 and web server 410, as depicted in FIG. 4 and described below, may have a similar structure and components that are similar to those described with respect to currency transfer system 320 shown in FIG. 3. As shown, the currency transfer system 320 may include a processor 310, an input/output (I/O) device 370, a memory 330 containing an operating system (OS) 340 and a program 350. In certain example implementations, the currency transfer system 320 may be a single server or may be configured as a distributed computer system including multiple servers or computers that interoperate to perform one or more of the processes and functionalities associated with the disclosed embodiments. In some embodiments currency transfer system 320 may be one or more servers from a serverless or scaling server system. In some embodiments, the currency transfer system 320 may further include a peripheral interface, a transceiver, a mobile network interface in communication with the processor 310, a bus configured to facilitate communication between the various components of the currency transfer system 320, and a power source configured to power one or more components of the currency transfer system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the currency transfer system 320 may include one or more storage devices configured to store information used by the processor 310 (or other components) to perform certain functions related to the disclosed embodiments. In one example, the currency transfer system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The currency transfer system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the currency transfer system 320 may include the memory 330 that may include one or more programs 350 to perform one or more functions of the disclosed embodiments. For example, in some embodiments, the currency transfer system 320 may additionally manage dialogue and/or other interactions with the customer via a program 350.

The processor 310 may execute one or more programs 350 located remotely from the currency transfer system 320. For example, the currency transfer system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a currency transfer system database 360 for storing related data to enable the currency transfer system 320 to perform one or more of the processes and functionalities associated with the disclosed embodiments.

The currency transfer system database 360 may include stored data relating to status data (e.g., average session duration data, location data, idle time between sessions, and/or average idle time between sessions) and historical status data. According to some embodiments, the functions provided by the currency transfer system database 360 may also be provided by a database that is external to the currency transfer system 320, such as the database 416 as shown in FIG. 4.

The currency transfer system 320 may also be communicatively connected to one or more memory devices (e.g., databases) locally or through a network. The remote memory devices may be configured to store information and may be accessed and/or managed by the currency transfer system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The currency transfer system 320 may also include one or more I/O devices 370 that may comprise one or more interfaces for receiving signals or input from devices and providing signals or output to one or more devices that allow data to be received and/or transmitted by the currency transfer system 320. For example, the currency transfer system 320 may include interface components, which may provide interfaces to one or more input devices, such as one or more keyboards, mouse devices, touch screens, track pads, trackballs, scroll wheels, digital cameras, microphones, sensors, and the like, that enable the currency transfer system 320 to receive data from a user (such as, for example, via the user device 402).

In examples of the disclosed technology, the currency transfer system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the currency transfer system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the currency transfer system 320 may include a greater or lesser number of components than those illustrated.

FIG. 4 is a block diagram of an example system that may be used to use and interact with virtual reality system 408, according to an example implementation of the disclosed technology. The components and arrangements shown in FIG. 4 are not intended to limit the disclosed embodiments as the components used to implement the disclosed processes and features may vary. As shown, virtual reality system 408 may interact with a user device 402 via a network 406. In certain example implementations, the virtual reality system 408 may include a local network 412, a currency transfer system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the virtual reality system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the virtual reality system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The user device 402 may be a virtual reality device such as a headset or cell phone with virtual reality (VR) capabilities. The user device 402 may include one or more displays and one or more cameras. The user device may also include an array of sensors, including, for example cameras to watch the user's environment, cameras to watch the user's actions or impressions (e.g., facial expressions, blinking, or arm movements), microphones to listen to user or the user's environment, accelerometers, gyrometers, fingerprint scanners, retinal scanners, and other similar sensors known in the art. The user device 402 may contain tactile control devices such as a joystick. The user device 402 may also include the ability to communicate using near field communication (NFC), Bluetooth, WiFi, cellular data or other technologies known in the art. The user device 402 may be linked with the user's cell phone. The user device 402 may be running software that allows it to uniquely interface with virtual reality system 408. Virtual reality system 408 and currency transfer system 320 may be able to interact directly with the sensors on user device 402. User device 402 may be a first user device 402. The system may also include second user device 404, which may be the same as, have any the same features as, or be similar to user device 402. User devices 402, 404 may have similar hardware to currency transfer system 320. Although user devices 402, 404 are depicted in FIG. 4 as smart phones, they may also be virtual reality or augmented reality headsets or other types of AR/VR devices.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The virtual reality system 408 may be associated with and optionally controlled by one or more entities such as a business, corporation, individual, partnership, or any other entity that provides one or more of goods, services, and consultations to individuals such as customers. In some embodiments, the virtual reality system 408 may be controlled by a third party on behalf of another business, corporation, individual, partnership. The virtual reality system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the currency transfer system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the virtual reality system 408 to interact with one another and to connect to the network 406 for interacting with components in the system 400 environment. In some embodiments, the local network 412 may include an interface for communicating with or linking to the network 406. In other embodiments, certain components of the virtual reality system 408 may communicate via the network 406, without a separate local network 406.

The virtual reality system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access virtual reality system 408 using the cloud computing environment. User device 402 may be able to access virtual reality system 408 using specialized software. The cloud computing environment may eliminate the need to install specialized software on user device 402.

In accordance with certain example implementations of the disclosed technology, the virtual reality system 408 may include one or more computer systems configured to compile data from a plurality of sources the currency transfer system 320, web server 410, and/or the database 416. The currency transfer system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

FIG. 5 is a timing diagram illustrating an example sequence for providing authentication information to a client device 510 (e.g., user device 402) via a contactless transaction card. System 500 may comprise contactless card 505 and client device 510, which may include an application 522 and processor 524. The contactless card 505 may also be capable of executing transactions.

At step 502, the application 522 may communicate with the contactless card 505 (e.g., after being brought near the contactless card 505). Communication between the application 522 and the contactless card 505 may involve the contactless card 505 being sufficiently close to a card reader (not shown) of the client device 510 to enable NFC data transfer between the application 522 and the contactless card 505.

At step 504, after communication has been established between client device 510 and contactless card 505, the contactless card 505 generates a message authentication code (MAC) cryptogram. In some examples, this may occur when the contactless card 505 is read by the application 522. In particular, this may occur upon a read, such as an NFC read, of a near field data exchange (NDEF) tag, which may be created in accordance with the NFC Data Exchange Format. For example, a reader, such as application 522, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 505 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string).

In some examples, application 522 may be configured to transmit a request to contactless card 505, the request comprising an instruction to generate a MAC cryptogram.

At step 506, the contactless card 505 sends the MAC cryptogram to the application 522. In some examples, the transmission of the MAC cryptogram occurs via NFC, however, the present disclosure is not limited thereto. In other examples, this communication may occur via Bluetooth, Wi-Fi, or other means of wireless data communication.

At step 508, the application 522 communicates the MAC cryptogram to the processor 524.

At step 512, the processor 524 verifies the MAC cryptogram pursuant to an instruction from the application 522. For example, the MAC cryptogram may be verified, as explained below.

In some examples, verifying the MAC cryptogram may be performed by a device other than client device 510, such as a server in data communication with the client device. For example, processor 524 may output the MAC cryptogram for transmission to server, which may verify the MAC cryptogram.

In some examples, the MAC cryptogram may function as a digital signature for purposes of verification or for identity authentication. Other digital signature algorithms, such as public key asymmetric algorithms, e.g., the Digital Signature Algorithm and the RSA algorithm, or zero knowledge protocols, may be used to perform this verification.

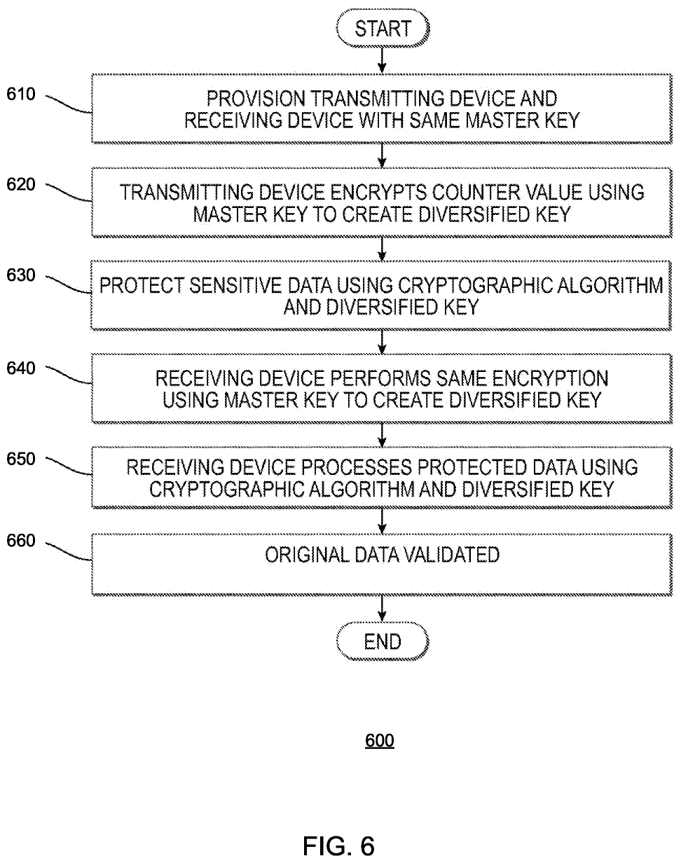

FIG. 6 illustrates a method 600 of key diversification according to an example of the present disclosure for providing authentication information to a receiving device (e.g., user device 402) via a contactless transaction card. Method 600 may include a transmitting device and receiving device similar to contactless card 505 and client device 510 referenced in FIG. 5.

For example, a sender and recipient may desire to exchange data (e.g., original sensitive data) via a transmitting device and a receiving device. As explained above, although these two parties may be included, it is understood that one or more transmitting devices and one or more receiving devices may be involved so long as each party shares the same shared secret symmetric key. In some examples, the transmitting device and receiving device may be provisioned with the same master symmetric key. Further, it is understood that any party or device holding the same secret symmetric key may perform the functions of the transmitting device and similarly any party holding the same secret symmetric key may perform the functions of the receiving device. In some examples, the symmetric key may comprise the shared secret symmetric key which is kept secret from all parties other than the transmitting device and the receiving device involved in exchanging the secure data. It is further understood that both the transmitting device and receiving device may be provided with the same master symmetric key, and further that part of the data exchanged between the transmitting device and receiving device comprises at least a portion of data which may be referred to as the counter value. The counter value may comprise a number that changes each time data is exchanged between the transmitting device and the receiving device.

At block 610, a transmitting device and receiving device may be provisioned with the same master key, such as the same master symmetric key. When the transmitting device is preparing to process the sensitive data with symmetric cryptographic operation, the sender may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm, such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

The transmitting device may take the selected cryptographic algorithm, and using the master symmetric key, process the counter value. For example, the sender may select a symmetric encryption algorithm, and use a counter which updates with every conversation between the transmitting device and the receiving device.

At block 620, the transmitting device may then encrypt the counter value with the selected symmetric encryption algorithm using the master symmetric key, creating a diversified symmetric key. The diversified symmetric key may be used to process the sensitive data before transmitting the result to the receiving device. For example, the transmitting device may encrypt the sensitive data using a symmetric encryption algorithm using the diversified symmetric key, with the output comprising the protected encrypted data. The transmitting device may then transmit the protected encrypted data, along with the counter value, to the receiving device for processing. In some examples, a cryptographic operation other than encryption may be performed, and a plurality of cryptographic operations may be performed using the diversified symmetric keys prior to transmittal of the protected data.

In some examples, the counter value may not be encrypted. In these examples, the counter value may be transmitted between the transmitting device and the receiving device at block 420 without encryption.

At block 630, sensitive data may be protected using one or more cryptographic algorithms and the diversified keys. The diversified session keys, which may be created by the key diversification which uses the counter, may be used with one or more cryptographic algorithms to protect the sensitive data. For example, data may be processed by a MAC using a first diversified session key, and the resulting output may be encrypted using the second diversified session key producing the protected data.

At block 640, the receiving device may perform the same symmetric encryptions using the counter value as input to the encryptions and the master symmetric keys as the keys for the encryption. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key.

At block 650, the receiving device may use the diversified keys with one or more cryptographic algorithms to validate the protected data.

At block 660, the original data may be validated. If the output of the MAC operation (via the receiving device using the first diversified session key) matches the MAC output revealed by decryption, then the data may be deemed valid.

The next time sensitive data needs to be sent from the transmitting device to the receiving device, a different counter value may be selected, which produces a different diversified symmetric key. By processing the counter value with the master symmetric key and same symmetric cryptographic algorithm, both the transmitting device and receiving device may independently produce the same diversified symmetric key. This diversified symmetric key, not the master symmetric key, is used to protect the sensitive data.

As explained above, both the transmitting device and receiving device each initially possess the shared master symmetric key. The shared master symmetric key is not used to encrypt the original sensitive data. Because the diversified symmetric key is independently created by both the transmitting device and receiving device, it is never transmitted between the two parties. Thus, an attacker cannot intercept the diversified symmetric key and the attacker never sees any data which was processed with the master symmetric key. Only the small counter value is processed with the master symmetric key, not the sensitive data. As a result, reduced side-channel data about the master symmetric key is revealed. Moreover, the sender and the recipient may agree, for example by prior arrangement or other means, how often to create a new diversification value, and therefore a new diversified symmetric key. In an embodiment, a new diversification value and therefore a new diversified symmetric key may be created for every exchange between the transmitting device and receiving device.

In some examples, the key diversification value may comprise the counter value. Other non-limiting examples of the key diversification value include: a random nonce generated each time a new diversified key is needed, the random nonce sent from the transmitting device to the receiving device; the full value of a counter value sent from the transmitting device and the receiving device; a portion of a counter value sent from the transmitting device and the receiving device; a counter independently maintained by the transmitting device and the receiving device but not sent between the two; a one-time-passcode exchanged between the transmitting device and the receiving device; cryptographic hash of the sensitive data. In some examples, one or more portions of the key diversification value may be used by the parties to create multiple diversified keys. For example, a counter may be used as the key diversification value.

In another example, a portion of the counter may be used as the key diversification value. If multiple master key values are shared between the parties, the multiple diversified key values may be obtained by the system and processes described herein. A new diversification value, and therefore a new diversified symmetric key, may be created as often as needed. In the most secure case, a new diversification value may be created for each exchange of sensitive data between the transmitting device and the receiving device. In effect, this may create a one-time use key, such as a single session key.

In other examples, such as to limit the number of times of use of the master symmetric key, it may be agreed upon by the sender of transmitting device and recipient of the receiving device that a new diversification value, and therefore a new diversified symmetric key, will happen only periodically. In one example, this may be after a pre-determined number of uses, such as every 10 transmissions between the transmitting device and the receiving device. In another example, this may be after a certain time period, a certain time period after a transmission, or on a periodic basis (e.g., daily at a designated time; weekly at a designated time on a designated day). In another example, this may be every time the receiving device signals to the transmitting device that it desires to change the key on the next communication. This may be controlled on policy and may be varied due to, for example, the current risk level perceived by the recipient of the receiving device.

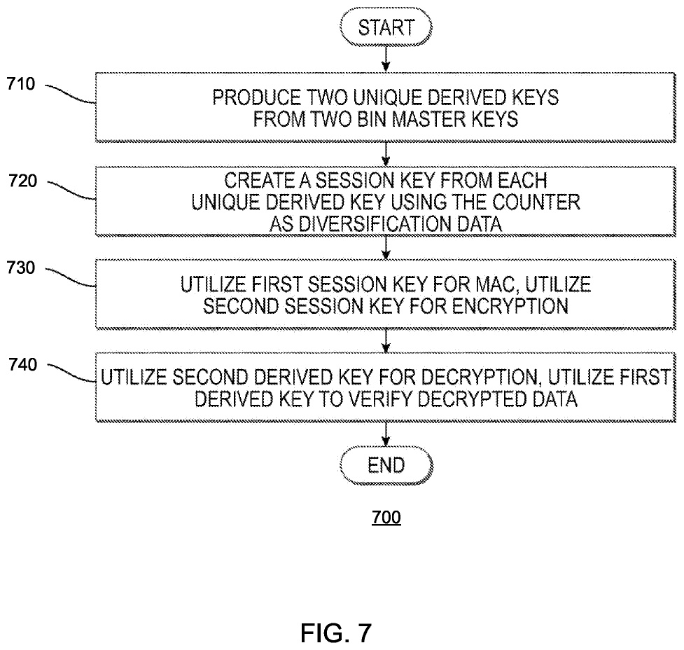

FIG. 7 is a flowchart illustrating key operations 700 according to an example embodiment for providing authentication information to a client device 510 (e.g., user device 402) via a contactless transaction card. As illustrated in FIG. 7, at block 710, two bank identifier number (BIN) level master keys may be used in conjunction with the account identifier and card sequence number to produce two unique derived keys (UDKs) per card. In some examples, a bank identifier number may comprise one number or a combination of one or more numbers, such as an account number or an unpredictable number provided by one or more servers, may be used for session key generation and/or diversification. The UDKs (AUTKEY and ENCKEY) may be stored on the card during the personalization process.

At block 720, the counter may be used as the diversification data, since it changes with each use and provides a different session key each time, as opposed to the master key derivation in which one unique set of keys per card is produced. In some examples, it is preferable to use the 4-byte method for both operations. Accordingly, at block 720, two session keys may be created for each transaction from the UDKs, i.e., one session key from AUTKEY and one session key from ENCKEY. In the card, for the MAC key (i.e., the session key created from AUTKEY), the low order of two bytes of the OTP counter may be used for diversification. For the ENC key (i.e., the session key created from ENCKEY), the full length of the OTP counter may be used for the ENC key.

At block 730, the MAC key may be used for preparing the MAC cryptogram, and the ENC key may be used to encrypt the cryptogram. For example, the MAC session key may be used to prepare the cryptogram, and the result may be encrypted with the ENC key before it is transmitted to the one or more servers.

At block 740, verification and processing of the MAC is simplified because 2-byte diversification is directly supported in the MAC authentication functions of payment HSMs. Decryption of the cryptogram is performed prior to verification of the MAC. The session keys are independently derived at the one or more servers, resulting in a first session key (the ENC session key) and a second session key (the MAC session key). The second derived key (i.e., the ENC session key) may be used to decrypt the data, and the first derived key (i.e., the MAC session key) may be used to verify the decrypted data.

For the contactless card, a different unique identifier is derived which may be related to the application primary account number (PAN) and PAN sequence number, which is encoded in the card. The key diversification may be configured to receive the identifier as input with the master key such that one or more keys may be created for each contactless card. In some examples, these diversified keys may comprise a first key and a second key. The first key may include an authentication master key (Card Cryptogram Generation/Authentication Key—Card-Key-Auth), and may be further diversified to create a MAC session key used when generating and verifying a MAC cryptogram. The second key may comprise an encryption master key (Card Data Encryption Key—Card-Key-DEK), and may be further diversified to create an ENC session key used when encrypting and decrypting enciphered data. In some examples, the first and the second keys may be created by diversifying the issuer master keys by combining them with the card's unique ID number (pUID) and the PAN sequence number (PSN) of a payment applet. The pUID may comprise a 16-digit numerical value. As explained above, pUID may comprise a 16 digit BCD encoded number. In some examples, pUID may comprise a 14-digit numerical value.

In some examples, since the EMV session key derivation method may wrap at 2\hat{ }16 uses, the counter such as the full 32-bit counter may be added to the initialization arrays of the diversification method.

In other examples, such as credit cards, a number, such as an account number or an unpredictable number provided by one or more servers, may be used for session key generation and/or diversification.

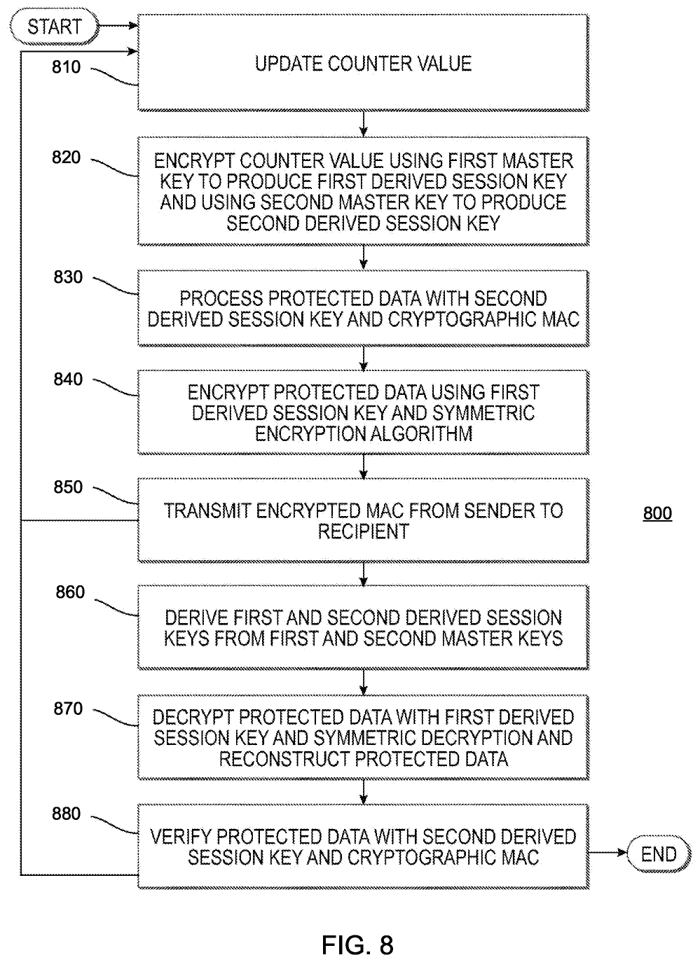

FIG. 8 depicts an exemplary process 800 illustrating key diversification according to one example for providing authentication information to a client device 510 (e.g., user device 402) via a contactless transaction card. Initially, a sender (e.g., a transaction card) and the recipient (e.g., user device 402) may be provisioned with two different master keys. For example, a first master key may comprise the data encryption master key, and a second master key may comprise the data integrity master key. The sender has a counter value, which may be updated at block 810, and other data, such as data to be protected, which it may secure share with the recipient.

At block 820, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 830, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 840, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 850, the encrypted MAC is transmitted, from the sender to the recipient, with sufficient information to identify additional secret information (such as shared secret, master keys, etc.), for verification of the cryptogram.

At block 860, the recipient uses the received counter value to independently derive the two derived session keys from the two master keys as explained above.

At block 870, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 880, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 810) and a new set of session keys may be created (at block 820). In some examples, the combined random data may be discarded.

Example embodiments of systems and methods described herein may be configured to provide security factor authentication. The security factor authentication may comprise a plurality of processes. As part of the security factor authentication, a first process may comprise logging in and validating a user via one or more applications executing on a device (e.g., user device 402). As a second process, the user may, responsive to successful login and validation of the first process via the one or more applications, engage in one or more behaviors associated with one or more contactless cards. In effect, the security factor authentication may include both securely proving identity of the user and engaging in one or more types of behaviors, including but not limited to one or more tap gestures, associated with the contactless card. In some examples, the one or more tap gestures may comprise a tap of the contactless card by the user to a device (e.g., user device 402).

In some examples, the contactless card may be tapped to a device, such user device 402, to verify identity so as to receive a transactional item responsive to a purchase or transfer. For example, an encrypted transaction may occur between the contactless card and the device, which may be configured to process one or more tap gestures. As explained above, the one or more applications may be configured to validate identity of the user and then cause the user to act or respond to it, for example, via one or more tap gestures. In some examples, data for example, may be written back to the contactless card. In some embodiments, the example authentication communication protocol may mimic an offline dynamic data authentication protocol of the EMV standard that is commonly performed between a transaction card and a point-of-sale device, with some modifications.

In some examples, the contactless card may be tapped to a device, such as a mobile device. As explained above, identity of the user may be verified by the one or more applications which would then grant the user a desired benefit based on verification of the identity.

### Example Use Case

The following example use case describes an example of a typical user flow pattern. This section is intended solely for explanatory purposes and not in limitation.

In one example, a user, Chris, has a virtual reality headset and is a user of a virtual reality environment. John is a friend of his and another user in the virtual reality environment. Chris' avatar is in a virtual reality environment and is located near John's avatar. Chris, through his virtual reality headset, can see and interact with John's avatar using his avatar. Chris decides to give John $10. Using his virtual reality headset and via one or more user inputs or gestures recognized by one or more cameras and/or sensors of the virtual reality headset, Chris opens his virtual reality inventory and selects a transaction card (the first virtual reality item) (block 102). After selecting the transaction card, a prompt opens on the display of Chris' virtual reality headset asking Chris for an amount and to choose an account. Chris, via one or more user inputs or gestures recognized by one or more cameras and/or sensors of his virtual reality headset, chooses a denomination of US dollars, an amount of $10 from his checking account, nicknamed “Chris' Checking” (block 104). Chris' transaction card is now viewable by him and John in the virtual reality environment via their respective virtual reality headsets. Meanwhile, John opens his virtual reality inventory and, via one or more user inputs or gestures recognized by one or more cameras and/or sensors of the virtual reality headset, selects a wallet (the second virtual reality item) (block 106). John's user account is setup to automatically have all transactions go into his PayPal account. John's wallet is now viewable by Chris and John in the virtual reality environment via their respective virtual reality headsets. Chris sees, through his display of his virtual reality headset, John's wallet. Chris moves his transaction card to be right on top of or next to John's wallet (block 108). A message pops up on both of Chris' and John's virtual headset display to “Hold for 5 seconds to transfer” with a timer graphic with a second hand counting down from five (5). After holding the position, another message pops up on both of Chris' and John's virtual headset display indicating “Transfer Accepted” (block 110). At this time, John's PayPal username is retrieved by currency transfer system 320 (block 112). Then, currency transfer system 320 retrieves or receives Chris' routing number and account number (block 114). The currency transfer system 320 then determines that Chris needs to authorize this transaction. The currency transfer system 320 sends a request to Chris' virtual reality headset to authenticate the transfer. Chris sees a prompt on his display asking him to authenticate the transaction. Chris makes an authentication gesture (e.g., two thumbs up) which is recorded by one or more cameras on his virtual reality headset. Chris' virtual reality headset relays the transaction information regarding the authentication gesture to the currency transfer system 320. The currency transfer system 320 receives the information regarding the authentication gesture and determines that it is a match to a stored authentication gesture. Currency transfer system 320 then sends Chris' and John's account information and the transaction information, along with information that Chris was authenticated, to the payment processor 430 (block 116). The payment processor 430 processes the transfer and sends a notification to the currency transfer system 320 regarding the completion of the transfer. The currency transfer system 320 then sends a notification to Chris' virtual reality headset and John's virtual reality headset that the transfer has been completed.

In another example, Chris is in a virtual reality environment and sees a pair of virtual shoes he would like to use in the virtual reality environment. Chris decides to buy the shoes. Using his virtual reality headset, Chris opens his virtual reality inventory and selects a transaction card (the first virtual reality item) using one or more user inputs or gestures recognized by the virtual reality headset (block 202). Chris moves his transaction card to be right on top of the shoes (block 204) using one or more user input devices or gestures recognized by the virtual reality headset. A message pops up on the headset to “Hold for 5 seconds to purchase” with a timer graphic with a second hand counting down from five (5). After holding the position, another message pops up indicating “Transferring Funds” (block 210). At this time, the store transfers transfer information about the shoes (e.g., the price) and store account information (e.g., a bank account number and routing information) (block 212). Then, currency transfer system 320 retrieves or receives Chris' routing number and account number are retrieved (block 214). Currency transfer system 320 then sends Chris' information, the store's account information and the transfer information to the payment processor 430 (block 216). The payment processor 430 processes the transfer and sends a notification to the currency transfer system 320 regarding the completion of the transfer. The currency transfer system 320 then sends a notification to Chris' headset that the transfer has been completed. The currency transfer system 320 also notifies the store that the transfer has been completed. Chris is then able to pick up or select the virtual shoes and add the virtual shoes to his virtual reality inventory.

In some examples, disclosed systems or methods may involve one or more of the following clauses:

Clause 1: A virtual reality system comprising: one or more processors; memory in communication with the one or more processors and storing instructions that are configured to cause the system to: receive, from a first user device, a first input indicating a first selection of a first virtual reality item associated with a first user; receive, from the first user device, transfer information comprising an amount to transfer to a second user; receive, from a second user device associated with the second user, a second input indicating a second selection of a second virtual reality item associated with the second user; receive, from the first user device, a third input indicating a first movement of the first virtual reality item; determine whether the first virtual reality item is in proximity to the second virtual reality item; responsive to determining that the first virtual reality item is in proximity to the second virtual reality item, initiate a peer-to-peer transfer by: retrieving second user account information associated with the second user; retrieving first user account information associated with the first user; and transmitting, to a payment processor indicated by the first user account information, the first user account information, the second user account information, and the transfer information.

Clause 2: The system of clause 1, wherein the first virtual reality item is in proximity to the second virtual reality item when the first virtual reality item contacts the second virtual reality item in a virtual reality space.

Clause 3: The system of clause 1, wherein the first user account information further comprises a first identification and first payment platform of the first user, and the second user account information further comprises a second identification and second payment platform of the second user.

Clause 4: The system of clause 1, wherein determining whether the first virtual reality item is in proximity to the second virtual reality item further comprises: measuring a virtual distance from the first virtual reality item to the second virtual reality item; and determining whether the virtual distance is less than a predetermined threshold for a predetermined amount of time.

Clause 5: The system of clause 1, wherein: the first virtual reality item is a payment instrument; and the second virtual reality item is a wallet.

Clause 6: The system of clause 1, wherein the memory stores further instructions that are configured to cause the system to: generate and transmit a virtual reality graphical indication of a payment transfer to the first user device and the second user device in response to determining the first virtual reality item is in proximity to the second virtual reality item.

Clause 7: The system of clause 1, wherein the memory stores further instructions that are configured to cause the system to: transmit, to the first user device, a request to authenticate the peer-to-peer transfer; receive, from the first user device, authentication information; and determine that the first user is authenticated for the peer-to-peer transfer.

Clause 8: A virtual reality system comprising: one or more processors; memory in communication with the one or more processors and storing instructions that are configured to cause the system to: receive, from a first user device, a first input indicating a first selection of a first virtual reality item associated with a first user; receive, from the first user device, transfer information comprising an amount to request from a second user; receive, from a second user device, a second input indicating a second selection of a second virtual reality item associated with the second user; receive, from the second user device, a third input indicating a first movement of the second virtual reality item; determine whether the second virtual reality item is in proximity to the first virtual reality item; responsive to determining that the second virtual reality item is in proximity to the first virtual reality item, initiate a peer-to-peer transfer by: retrieving first user account information associated with the first user; retrieving second user account information associated with the second user; and transmitting, to a payment processor indicated by the second user account information, the first user account information, the second user account information, and the transfer information.

Clause 9: The system of clause 8, wherein the memory stores further instructions that are configured to cause the system to: transmit, to the second user device, a first request to authenticate the peer-to-peer transfer; receive, from the second user device, first authentication information; and determine that the second user is authenticated for the peer-to-peer transfer.

Clause 10: The system of clause 9, wherein the memory stores further instructions that are configured to cause the system to: receive, from the payment processor, a second request to authenticate the peer-to-peer transfer; and transmit, to the payment processor, a message that the second user is authenticated.

Clause 11: The system of clause 9, wherein receiving, from the second user device, the first authentication information further comprises an authentication gesture captured the second user device.

Clause 12: The system of clause 9, wherein receiving, from the second user device, the first authentication information further comprises an iris scan captured by the second user device.

Clause 13: The system of clause 9, further comprising wherein the memory stores further instructions that are configured to cause the system to: display transfer information in response to the second user looking at the first virtual reality item.

Clause 14: The system of clause 9, wherein the memory stores further instructions that are configured to cause the system to: transmit, to the first user device, a second request to authenticate the peer-to-peer transfer; receive, from the first user device, second authentication information; and determine that the first user is authenticated for the peer-to-peer transfer.

Clause 15: The system of clause 14, wherein the memory stores further instructions that are configured to cause the system to: determine that the peer-to-peer transfer is authenticated; and transmit, to the payment processor, that the peer-to-peer transfer is authenticated.

Clause 16: An virtual reality system comprising: one or more processors; memory in communication with the one or more processors and storing instructions that are configured to cause the system to: receive, from a user device, a first input indicating a first selection of a first virtual reality item associated with a user; receive, from the user device, a second input indicating a first movement of the first virtual reality item; determine whether the first virtual reality item is in proximity to a purchasable item; responsive to determining that the first virtual reality item is in proximity to the purchasable item, initiate a transfer by: retrieving, from a store, transfer information regarding the purchasable item and store account information; retrieving user account information; and transmitting, to a payment processor, the user account information, the store account information, and the transfer information.

Clause 17: The system of clause 16, wherein retrieving the transfer information regarding the purchasable item further comprises scanning a virtual reality QR code associated with the purchasable item, the virtual reality QR code including the store account information and the transfer information.

Clause 18: The system of clause 16, wherein the memory stores further instructions that are configured to cause the system to: transmit, to the user device, a first request to authenticate the transfer; receive, from the user device, authentication information; determine that the user is authenticated for the transfer; and receive a payment confirmation.

Clause 19: The system of clause 16, wherein the memory stores further instructions that are configured to cause the system to: receive, from the payment processor, a request for authentication information; transmit, to the user device, a first request to authenticate the transfer; receive, from the user device, the authentication information; transmit, to the payment processor, the authentication information; and receive a payment confirmation.

Clause 20: The system of clause 16, further comprising wherein the memory stores further instructions that are configured to cause the system to: display transfer information in response to the user looking at the purchasable item.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic.

Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A virtual reality system comprising:
one or more processors;
memory in communication with the one or more processors and storing instructions that are configured to cause the system to:
receive, from a first user device, a first input indicating a first selection of a first virtual reality item associated with a first user;
receive, from the first user device, transfer information comprising an amount to transfer to a second user;
receive, from a second user device associated with the second user, a second input indicating a second selection of a second virtual reality item associated with the second user;
receive, from the first user device, a third input indicating a first movement of the first virtual reality item;
determine whether the first virtual reality item is in proximity to the second virtual reality item;
responsive to determining that the first virtual reality item is in proximity to the second virtual reality item, initiate a peer-to-peer transfer by:
retrieving second user account information associated with the second user;
retrieving first user account information associated with the first user; and
transmitting, to a payment processor indicated by the first user account information, the first user account information, the second user account information, and the transfer information.

2. The system of claim 1, wherein the first virtual reality item is in proximity to the second virtual reality item when the first virtual reality item contacts the second virtual reality item in a virtual reality space.

3. The system of claim 1, wherein the first user account information further comprises a first identification and first payment platform of the first user, and the second user account information further comprises a second identification and second payment platform of the second user.

4. The system of claim 1, wherein determining whether the first virtual reality item is in proximity to the second virtual reality item further comprises:
measuring a virtual distance from the first virtual reality item to the second virtual reality item; and
determining whether the virtual distance is less than a predetermined threshold for a predetermined amount of time.

5. The system of claim 1, wherein:
the first virtual reality item is a payment instrument; and
the second virtual reality item is a wallet.

6. The system of claim 1, wherein the memory stores further instructions that are configured to cause the system to:
generate and transmit a virtual reality graphical indication of a payment transfer to the first user device and the second user device in response to determining the first virtual reality item is in proximity to the second virtual reality item.

7. The system of claim 1, wherein the memory stores further instructions that are configured to cause the system to:
transmit, to the first user device, a request to authenticate the peer-to-peer transfer;
receive, from the first user device, authentication information; and
determine that the first user is authenticated for the peer-to-peer transfer.

8. A virtual reality system comprising:
one or more processors;
memory in communication with the one or more processors and storing instructions that are configured to cause the system to:
receive, from a first user device, a first input indicating a first selection of a first virtual reality item associated with a first user;
receive, from the first user device, transfer information comprising an amount to request from a second user;
receive, from a second user device, a second input indicating a second selection of a second virtual reality item associated with the second user;
receive, from the second user device, a third input indicating a first movement of the second virtual reality item;
determine whether the second virtual reality item is in proximity to the first virtual reality item;
responsive to determining that the second virtual reality item is in proximity to the first virtual reality item, initiate a peer-to-peer transfer by:
retrieving first user account information associated with the first user;
retrieving second user account information associated with the second user; and
transmitting, to a payment processor indicated by the second user account information, the first user account information, the second user account information, and the transfer information.

9. The system of claim 8, wherein the memory stores further instructions that are configured to cause the system to:
transmit, to the second user device, a first request to authenticate the peer-to-peer transfer;
receive, from the second user device, first authentication information; and
determine that the second user is authenticated for the peer-to-peer transfer.

10. The system of claim 9, wherein the memory stores further instructions that are configured to cause the system to:
receive, from the payment processor, a second request to authenticate the peer-to-peer transfer; and
transmit, to the payment processor, a message that the second user is authenticated.

11. The system of claim 9, wherein receiving, from the second user device, the first authentication information further comprises an authentication gesture captured the second user device.

12. The system of claim 9, wherein receiving, from the second user device, the first authentication information further comprises an iris scan captured by the second user device.

13. The system of claim 9, further comprising wherein the memory stores further instructions that are configured to cause the system to:
display transfer information in response to the second user looking at the first virtual reality item.

14. The system of claim 9, wherein the memory stores further instructions that are configured to cause the system to:
transmit, to the first user device, a second request to authenticate the peer-to-peer transfer;
receive, from the first user device, second authentication information; and
determine that the first user is authenticated for the peer-to-peer transfer.

15. The system of claim 14, wherein the memory stores further instructions that are configured to cause the system to:
determine that the peer-to-peer transfer is authenticated; and
transmit, to the payment processor, that the peer-to-peer transfer is authenticated.

16. A virtual reality system comprising:
one or more processors;
memory in communication with the one or more processors and storing instructions that are configured to cause the system to:
receive, from a user device, a first input indicating a first selection of a first virtual reality item associated with a user;
receive, from the user device, a second input indicating a first movement of the first virtual reality item;
determine whether the first virtual reality item is in proximity to a purchasable item;
responsive to determining that the first virtual reality item is in proximity to the purchasable item, initiate a transfer by:
retrieving, from a store, transfer information regarding the purchasable item and store account information;
retrieving user account information; and
transmitting, to a payment processor, the user account information, the store account information, and the transfer information.

17. The system of claim 16, wherein retrieving the transfer information regarding the purchasable item further comprises scanning a virtual reality QR code associated with the purchasable item, the virtual reality QR code including the store account information and the transfer information.

18. The system of claim 16, wherein the memory stores further instructions that are configured to cause the system to:
transmit, to the user device, a first request to authenticate the transfer;
receive, from the user device, authentication information;
determine that the user is authenticated for the transfer; and
receive a payment confirmation.

19. The system of claim 16, wherein the memory stores further instructions that are configured to cause the system to:
receive, from the payment processor, a request for authentication information;
transmit, to the user device, a first request to authenticate the transfer;
receive, from the user device, the authentication information;
transmit, to the payment processor, the authentication information; and
receive a payment confirmation.

20. The system of claim 16, further comprising wherein the memory stores further instructions that are configured to cause the system to:
display transfer information in response to the user looking at the purchasable item.
